(19) United States
(12) Patent Application Publication
(10) Pub. No.: US 2026/0366692 A1
(43) Pub. Date: Nov. 19, 2026

(54) LIGHT ENGINE AND LIGHTING DEVICE FOR A MOTOR VEHICLE PROVIDED WITH AT LEAST ONE LIGHT ENGINE AND A LIGHT GUIDE

(71) Applicant: VALEO VISION, Bobigny (FR)

(72) Inventor: Rabih TALEB, Bobigny (FR)

(73) Assignee: VALEO VISION, Bobigny (FR)

(21) Appl. No.: 19/475,916

(22) PCT Filed: Apr. 19, 2024
(86) PCT No.: PCT/EP2024/060820

§ 371 Date: Oct. 16, 2025

(30) Foreign Application Priority Data
Apr. 19, 2023 (FR) 2303917

(51) Int. Cl. F21S 43/249; F21S 43/14; F21S 43/20; F21S 43/237; F21S 43/242; F21S 43/245; F21S 43/27; F21V 8/00

(52) U.S. Cl. CPC F21S 43/2492; F21S 43/14; F21S 43/237; F21S 43/245; F21S 43/246; F21S 43/26231; F21S 43/27; G02B 6/001

(57) ABSTRACT

A luminous device including at least one light guide and a light engine. The light engine includes at least one light source and at least one housing, and a first and a second exit which are parallel or convergent and are each arranged in the housing. The light guide includes at least one first and one second segment each comprising only one connecting portion extending as far as an intersection point with the second segment or the first segment, and a lighting portion. Each of the exits of the light engine receives at least part of the connecting portion of the first and the second segment of the light guide.

### TECHNICAL FIELD

The present invention relates to the field of automotive-vehicle lighting.

The present invention relates more particularly to a light engine, to a luminous device provided with at least one light engine and one light guide, and to an assembly comprising a plurality of luminous devices.

The present invention is particularly but non-limitingly applicable to automotive vehicles.

### BACKGROUND OF THE INVENTION

In general, an automotive vehicle is equipped with a plurality of lighting assemblies configured for the lighting and signaling of the automotive vehicle. The lighting assemblies are most often located on the front part and rear part of the automotive vehicle.

According to an example shown in FIG. 1, a front portion 10 of an automotive vehicle comprises a bumper 12, a radiator grille 14 and a lighting assembly 20 integrated in the radiator grille 14. The lighting assembly 30 comprises two luminous devices 300 each comprising a light engine 32 connected to a light guide 34.

Each light engine 32 of the luminous device 300 comprises a light source 320 which emits light into the light guide 34. The light guide 34 is an optical part capable of guiding the light emitted by the light source 320 by successive total internal reflections of the light, from an entry zone to an exit zone. The light guide 34 is for example in the form of a tubular element.

Each light engine 32 of the lighting assembly 20 is arranged at an end of the radiator grille 14 in a transverse direction T of a frame of reference VLT. The light guide 34 extends transversely in the radiator grille 14 so as to illuminate the radiator grille 14 of the vehicle.

As shown in FIG. 2, the light engine 32 comprises an electronic mounting 324 on which the light source 320 is arranged, and a housing 326 comprising an exit 330 of the light engine 32. As illustrated in FIG. 2, the light engine 32 may also comprise a collimator 334 arranged between the light source 320 and the housing 326.

The light guide 34 comprises a segment 340 delimited by a first end 240A connected to the light source 320 of the light engine 32 and a second end 340B located outside of the light engine 32.

The segment 340 of the light guide 34 has two portions:
a connecting portion 342, arranged inside the light engine 32 and extending from the first end 340A of the segment 340 to the exit 330 of the light engine 32, and
a lighting portion 344, arranged outside of the light engine 32 and extending from the exit 330 of the light engine 32 to the second end 340B of the segment 340.

The two luminous devices 300 of the lighting assembly 30 are arranged such that:
the second ends 340B of the segments 340 coincide so as to form one and the same segment 340 in the form of a continuous line, and
the lighting assembly 30 is symmetrical with respect to a plane P2 parallel to a plane VL of the frame of reference VLT and passing through the second ends 240B of the segments 340 of the light guide 24.

The two light engines 32 of the lighting assembly 20 therefore make it possible to emit light into the segment 340 of the light guide 34 from the first end 340A to the second end 340B of the segment 340 of the light guide 34.

However, in the case of a very long light guide 34, for example having a length greater than 1 meter, the value of the luminance varies along the lighting portion 344 of the segment 340 of the light guide 34. Specifically, the value of the luminance decreases gradually from the first end 340A of the segment 340, that is to say at the point closest to the light source 320, toward the second end 340B of the segment 340, that is to say at the point farthest away from the light source 320. Consequently, the implementation of luminous animations, such as a scrolling of the light along the lighting portion 344 of the segment 340 of the light guide 34, also causes effects that involve a drop in the value of the luminance of the light guide 34. In addition, in the case of a light guide 34 of which the segment 340 has curved or angular portions, the value of the luminance varies non-uniformly such that a hotspot is formed at the curved or angular portion, and then the value of the luminance decreases downstream of the curved or angular portion of the segment 340 of the light guide 34.

Consequently, such a luminous device 300 does not make it possible to obtain a constant value of the luminance, or a constant luminous uniformity, over the entire lighting portion 344 of the segment 340 of the light guide 34 in the case of a light guide 34 which is very long and/or has a geometry that is not straight and/or provides a specific illumination.

### SUMMARY OF THE INVENTION

The invention offers a solution to the aforementioned problems by providing a light engine and a luminous device comprising at least one light engine and one light guide having a specific architecture.

A first aspect of the invention relates to a light engine comprising at least one light source, and at least one housing. The light engine comprises a first exit and a second exit which are parallel or convergent and are each arranged in the housing.

The light engine according to the invention makes it possible, by virtue of the presence of two exits, to simultaneously connect two segments of a light guide and thus to emit light into these two segments.

Advantageously, the light engine comprises a first light source and a second light source, and each of the first and the second exit extends as far as the first light source and the second light source, respectively.

Advantageously, the first light source is arranged so as to emit light rays toward the first exit and the second light source is arranged so as to emit light rays toward the second exit.

For example, the first and the second light source of the light engine are each arranged facing the first exit and the second exit, respectively, of the light engine.

Advantageously, each of the first and the second exit extends as far as the first light source and the second light source, respectively.

Advantageously, the light engine comprises two identical structures which are arranged side by side such that they are symmetrical with respect to a plane of symmetry. Such a configuration of the light engine makes it possible to simplify the process for manufacturing the light engine insofar as it is only necessary to duplicate the identical elements in the two structures to manufacture it.

Advantageously, the identical structures are interconnected, or in particular are secured to one another, so as to form a single unit. This makes it easier to grasp the light engine as an integral unit, in particular when the light engine is being mounted in a luminous device or in a lighting assembly.

Advantageously, according to an exemplary embodiment of the invention, each identical structure of the light engine comprises:
a light source;
a light-source mounting;
a collimator disposed in front of the light source;
a housing body in which a light passage exit intended for receiving a connecting portion of a segment of a light guide is integrated, said housing body being disposed in such a way that the passage exit faces the exit of the collimator.

The light source is preferably a light emitting diode.

A second aspect of the invention relates to a luminous device comprising at least one light guide and one light engine according to the first aspect of the invention and wherein:
the light guide comprises at least one first segment and one second segment, each comprising:
   a first end,
   a connecting portion extending from its first end to an intersection point between the first and the second segment, and
   a lighting portion extending from the intersection point,
each of the first and the second exit of the light engine receives at least part of the connecting portion of the first and the second segment, respectively, of the light guide.

The luminous device according to the invention makes it possible, by virtue of the presence of two exits of the light engine, to reduce the length of each of the segments of the light guide, thereby allowing the lighting distance of each light engine to be reduced and thus a constant value of the luminance along each lighting portion of the segments of the light guide, that is to say as far as the point farthest away from the light engine, to be obtained. Moreover, such a luminous device makes it possible, by virtue of the crossing of the connecting portions of the segments of the light guide, to ensure continuous light in the lighting portions of the first and the second segment of the light guide at the first and the second exit of the light engine. The proposed luminous device also has the advantage of implementing luminous animations in the first and the second segment of the light guide by selectively and sequentially turning on the light sources associated with these segments. It is also possible to vary the luminous intensity of the light sources in order to establish a difference in luminance between the various segments of the light guide, for example still with the aim of implementing a luminous animation.

Advantageously, when the light engine comprises two identical structures disposed symmetrically with respect to a plane of symmetry, the first and the second segment of the light guide are crossed such that the intersection point between the first and the second segment lies in the plane of symmetry of the light engine. In this way, the segments of the light guide are curved in the same way, thereby ensuring the same light transmission effectiveness in these two segments and thus a uniform transmission of light throughout the light guide.

Advantageously, the lighting portions of the first and the second segment form a continuous line so as to ensure the continuous geometry of the lighting portions of the first and the second segment of the light guide at their intersection point.

Advantageously, the luminous device comprises a first and a second guide sleeve for the first and the second segment of the light guide, the first and the second guide sleeve receiving at least part of the connecting portion of the first and the second segment, respectively, of the light guide. Such a feature makes it possible to ensure the correct positioning of the connecting portions of the first and the second segment of the light guide.

Advantageously, each of the first and the second guide sleeve is fitted at least partially into each of the first and the second exit, respectively, of the light engine. In this way, the guide sleeves are held in position by being inserted into the exits, and therefore it is possible to dispense with fixing means for fixing the sleeves to the light engine.

By way of example, each guide sleeve extends from the first ends of the first and the second segment of the light guide to the intersection point of the first and the second segment of the light guide. Such a feature makes it possible to hold the light guide in position substantially throughout the connecting portion of the first and the second segment of the light guide.

Advantageously, each guide sleeve is arranged between the first and the second exit of the light engine and the intersection point of the first and the second segment of the light guide. Such a feature makes it possible to arrange each guide sleeve outside of the light engine.

The first and the second guide sleeve are preferably convergent. Such a feature makes it possible to ensure the correct positioning of the intersection point of the first and the second segment of the light guide.

Advantageously, the first and the second guide sleeve have a greater stiffness than that of the light guide. Such a feature both allows the first and the second guide sleeve to guide the connecting portions of the first and the second segment of the light guide and makes it possible to ensure the correct positioning of the intersection point of the first and the second segment of the light guide. Specifically, the stiffness of the guide sleeves imposes a limit on the crossing of the segments, that is to say the limit position beyond which it is no longer possible for the segments to cross. Generally speaking, the limit position is located approximately close to the free end of the guide sleeves. This limit on the crossing means that the way in which the segments are curved is limited. In other words, the radius of curvature of the segments partially depends on the stiffness of the guide sleeves. This regulated radius of curvature makes it possible to impose an inflection that ensures good propagation of light in the segments, in particular in the curved portion, in order to minimize the loss of light at this location.

Advantageously, each of the first and the second guide sleeve is made from a semirigid plastics material such as silicone.

With preference, the first and the second guide sleeve are rigid so as to preserve their geometric shape.

The light guide preferably comprises at least one optical fiber.

Advantageously, the light guide comprises glass fibers or is made of plastic.

Advantageously, the light guide is adjustable and it is therefore possible to easily deform it so as to form curved or angular portions of the light guide. In other words, the light guide is flexible.

With preference, the light engine is symmetrical with respect to a plane perpendicular to the light source of the light engine and passing through the intersection point of the first and the second segment of the light guide.

Advantageously, the first and the second guide sleeve are symmetrical with respect to a plane perpendicular to the light source of the light engine and passing through the intersection point of the first and the second segment of the light guide.

Advantageously, the luminous device comprises an electronic control unit configured to selectively and sequentially manage the first and the second light source.

A third aspect of the invention relates to a lighting assembly comprising two luminous devices according to the invention and wherein the lighting portions of the second segments of the light guide are arranged facing one another in one same plane.

The lighting assembly according to the invention makes it possible, by virtue of the presence of two luminous devices, to obtain a very long light guide wherein the value of the luminance is constant along each lighting portion of the segments of the light guide, that is to say as far as the point farthest away from the light engine.

According to one exemplary embodiment of the lighting assembly, the lighting portions of the first and the second segment of the light guide form a continuous line so as to ensure continuous light in the lighting portions of the second segments of the light guide at their second end.

According to a variant of the abovementioned exemplary embodiment of the lighting assembly, the lighting portions of the first and the second segment of the light guide are aligned relative to one another so as to ensure a continuous geometry of the lighting portions of the second segments of the light guide at their second end.

According to another exemplary embodiment of the lighting assembly, the second ends of the second segments of the light guide are spaced apart from one another.

According to one particular embodiment of the lighting assembly, the second ends of the second segments of the light guide coincide so as to form one and the same second segment in the form of a continuous line extending from the first end of the first segment to the first end of the second segment.

Advantageously, the lighting assembly is symmetrical with respect to a plane passing through the second ends of the second segments of the light guide.

The invention and its various applications will be better understood on reading the following description and studying the accompanying figures.

### BRIEF DESCRIPTION OF THE DRAWINGS

Other advantages and features of the invention will become apparent on reading the following description, which is illustrated by the figures, in which:

FIG. 1, already described, is a perspective view from above of the front part of an automotive vehicle provided with a lighting assembly comprising two luminous devices according to the prior art;

FIG. 2, already described, is a schematic view from above of a lighting assembly comprising two luminous devices according to the prior art;

FIG. 3 is a schematic view from above of a luminous device according to a first embodiment of the invention;

FIG. 4 is a schematic view from above of a luminous device according to a second embodiment of the invention; and

FIG. 5 is a schematic view from above of a lighting assembly comprising two luminous devices according to the first embodiment of the invention.

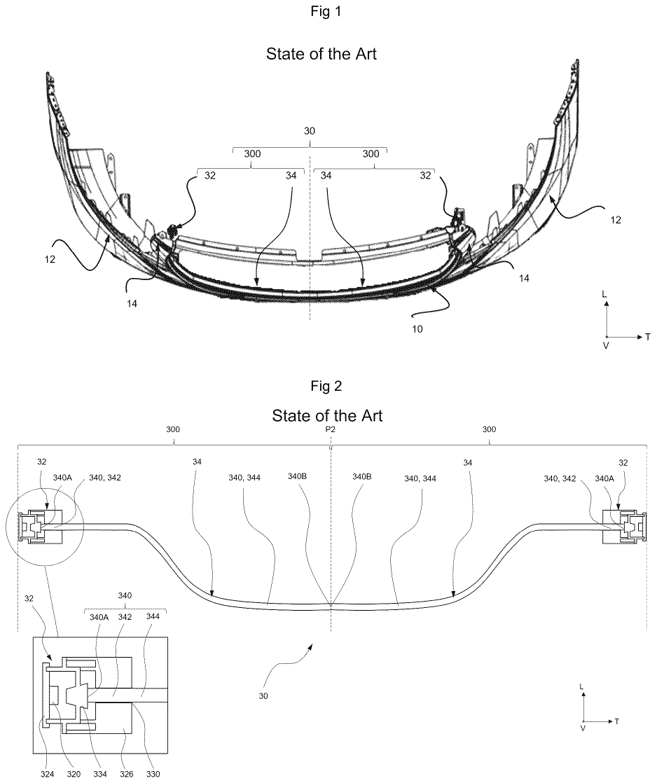

### DETAILED DESCRIPTION OF THE INVENTION

One exemplary embodiment of a luminous device according to the invention is described in detail below, with reference to the appended drawings. This example illustrates the features and advantages of the invention.

Unless stated otherwise, the same element appearing in different figures is provided with a single reference.

For the understanding of the invention, the vertical, longitudinal and transverse orientations as per the frame of reference V, L, T indicated in the figures, of which the longitudinal axis L and transverse axis T extend in a horizontal plane, will be adopted. The back of the luminous device toward the front of the luminous device is oriented along the longitudinal axis L of the frame of reference VLT.

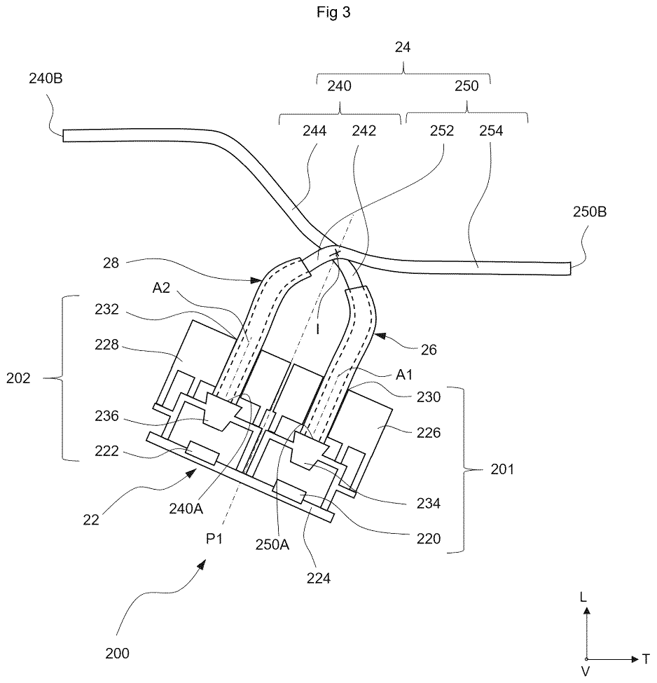

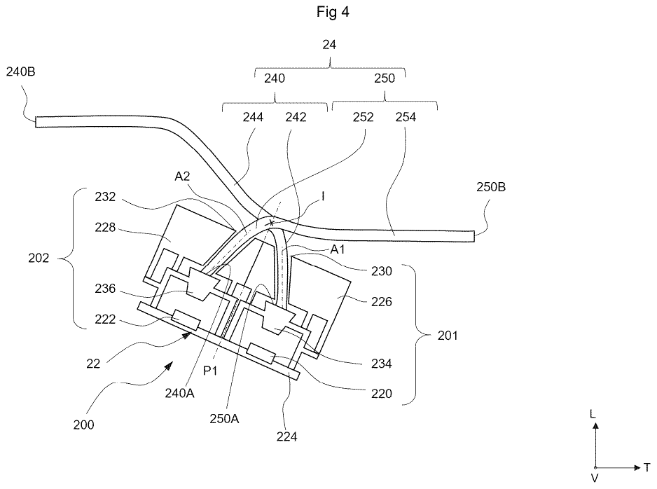

FIG. 3 and FIG. 4 each show a luminous device 200 comprising a light engine 22 connected to a light guide 24. FIG. 3 illustrates a luminous device 200 according to a first embodiment and FIG. 4 illustrates a luminous device 200 according to a second embodiment.

Each light engine 22 of the luminous device 200, according to the first and the second embodiment, comprises:
a first and a second light source 220, 222 which emit light into the light guide 24,
an electronic mounting 224 on which the first and the second light source 220, 222 are arranged,
a first and a second housing 226, 228, or housing body, arranged facing the first and the second light source 220, 222, respectively, and
a first and a second outlet 230, 232 which are parallel or convergent and are arranged in the first and the second housings 226, 228, respectively, and facing the first and the second light source 220, 222, respectively.

According to some embodiments of the light engine 22 of the luminous device 200, as shown in FIG. 3 and FIG. 4, the light engine 22 comprises a first and a second collimator 234, 236 arranged between the first and the second light source 220, 222, respectively, and the first and the second housing 226, 228, respectively.

Specifically, in the exemplary embodiments illustrated, each of the light engines 22 in FIG. 3 and FIG. 4 comprises two identical structures 201 and 202, referred to as first structure 201 and second structure 202. These structures are arranged side by side and are secured to one another so as to form a single unit.

In other words, the two structures 201 and 202 of the light engine 22 are symmetrical with respect to a plane of symmetry P1, that is to say one element in one of the two structures has its equivalent in the other structure and the element and its corresponding element are located on either side of the plane Pl and at the same spacing from this plane P1. This symmetrical arrangement forms a standard unit that can be applied in various use circumstances.

According to some embodiments, which are not shown, of the light engine 22 of the luminous device 200, the first and the second housing 226, 228 coincide so as to form one and the same component comprising the first and the second exit 230, 232 of the light engine 22.

Each of the structures 201 or 202 comprises:
a light source 220 or 222;
a light-source mounting 224;
a collimator 234 or 236 which is disposed in front of the light source;
a housing or a housing body 226 or 228 which is connected to the collimator and in which a light passage exit 230, 232 is integrated, said housing body being disposed such that the passage exit faces the exit of the collimator.

In the example described, since the structures 201 and 202 are disposed side by side, they share the same mounting 224 for the light sources.

Advantageously, each of the first and the second light source 220, 222 is a light emitting diode.

The light guide 24 is for example in the form of a tubular element of which the cross section can have various shapes and/or of which the size can vary along the light guide 24 in the transverse direction T.

The light guide 24 may comprise glass fibers, plastics fibers or an assembly of at least one optical fiber encapsulated in a sheath. Glass fibers are for example overmolded at one end in a plastics material, or adhesively bonded together at one end by means of an adhesive. The plastics fibers are for example made from a transparent plastics material such as polymethyl methacrylate (PMMA).

The light guide 24 is adjustable, that is to say a flexible component which deforms easily so as to modify its geometrical shape and thus form various predetermined curved or angular portions between the first and the second end 240A, 250A of the light guide 24.

The light guide 24 comprises a first and a second segment 240, 250 each delimited by a first end 240A, 250A located in the light engine 22 and connected to the first and the second light source 220, 222, respectively, and a second end 240B, 250B located outside of the light engine 22.

The first and the second segment 240, 250 of the light guide 24 are crossed so as to form an intersection point I of the first and the second segment 240, 250, this intersection point being located close to the first and the second exit 230, 232 of the light engine 22.

Advantageously, if the light guide 24 has at least one curved or angular portion, the intersection point I of the first and the second segment 240, 250 is located at the curvature or angle of the light guide 24. Such a feature makes it possible to obtain a constant value of the luminance along each of the first and the second segment 240, 250 of the light guide 24, in particular at the curved or angular portion of the light guide 24.

Advantageously, the light engine 22 of the luminous device 200 is symmetrical with respect to the plane of symmetry P1 which is perpendicular to the electronic mounting 224 of the light engine 22 and passes through the intersection point I of the first and the second segment 240, 250 of the light guide 24.

Each of the first and the second segment 240, 250 of the light guide 24, as shown in FIG. 3 and FIG. 4, comprises only two portions:
a connecting portion 242, 252 extending from the first end 240A, 250A of the first and the second segment 240, 250 to the intersection point I, and
a lighting portion 244, 254 extending from the intersection point I to the second end 240B, 250B of the first and the second segment 240, 250.

As shown in FIG. 3 and FIG. 4, the connecting portions 242, 252 of the first and the second segment 240, 250 pass through the first and the second exit 230, 232, respectively, of the light engine 22. Moreover, the lighting portions 244, 254 of the first and the second segment 240, 250 form a continuous line so as to ensure the continuous geometry of the lighting portions 244, 254 of the first and the second segment 240, 250 of the light guide 24, at their intersection point I.

The luminous device 200 according to the first embodiment shown in FIG. 3 comprises a light engine 22 in which the first and the second exit 230, 232 are mutually parallel. Each of the first and the second exit 230, 232 is in the form of a substantially cylindrical hole of main axis A1, A2 passing through each of the first and the second housing 226, 228, respectively. The first and the second exit 230, 232 are referred to as parallel when the main axes A1 and A2 are mutually parallel.

In addition, the luminous device 200 according to this first embodiment comprises a first and a second guide sleeve 26, 28 for the first and the second segment 240, 250 of the light guide 24. The first and the second guide sleeve 26, 28 receive at least part of the connecting portion 242, 252 of the first and the second segment 240, 250, respectively, of the light guide 24 to ensure the correct positioning of the connecting portions 242, 252 of the first and the second segment 240, 250 of the light guide 24 and the correct positioning of the intersection point I.

According to an example illustrated in FIG. 3, each guide sleeve 26, 28 extends from the first ends 240A, 250A of the first and the second segment 240, 250 of the light guide 24 to upstream of the intersection point I of the first and the second segment 240, 250 of the light guide 24. In this case, each of the first and the second guide sleeve 26, 28 passes through the first and the second exit 226, 228, respectively, of the light engine 22.

According to another example, which is not shown, each guide sleeve 26, 28 is arranged between the first and the second exit 230, 232 of the light engine 22 and upstream of the intersection point I of the first and the second segment 240, 250 of the light guide 24. In this case, each of the first and the second guide sleeve 26, 28 is arranged outside of and downstream of the light engine 22.

The intersection point I of the first and the second segment 240, 250 of the light guide 24 is not covered by the first and the second guide sleeve 26, 28 so as to create a continuous line of light formed by the lighting portions 244, 254 of the first and the second segment 240, 250 of the light guide 24 of the luminous device 200, that is to say extending from the second end 240B of the first segment 240 to the second end 250B of the second segment 250 of the light guide 24.

As shown in FIG. 3, the first and the second guide sleeve 26, 28 are convergent. Advantageously, each of the first and the second guide sleeve 26, 28 has a curvature of which the concave side is oriented toward the second guide sleeve 28 or the first guide sleeve 26, respectively.

Advantageously, the first and the second guide sleeve 26, 28 are symmetrical with respect to the plane P1.

Advantageously, the first and the second guide sleeve 26, 28 have a greater stiffness than that of the light guide 24, thereby both allowing the first and the second guide sleeve 26, 28 to guide the connecting portions 242, 252 of the first and the second segment 240, 250 of the light guide 24 and making it possible to ensure the correct positioning of the intersection point I of the first and the second segment 240, 250 of the light guide 24.

Each of the first and the second guide sleeve 26, 28 is made from a semirigid plastics material such as silicone.

The first and the second guide sleeve 26, 28 may also be rigid, i.e. non-deformable, so as to preserve their geometric shape.

The luminous device 200 according to the second embodiment shown in FIG. 4 comprises a light engine 22 in which the first and the second exit 230, 232 are convergent. Each of the first and the second exit 230, 232 is in the form of a substantially cylindrical hole of main axis A1, A2 passing through each of the first and the second housing 226, 228, respectively. The exits are convergent when the main axes P1 and P2 cross at a point P located downstream of the first and the second exit 230, 232. In this embodiment, each of the first and the second exit 230, 232 of the light engine 22 extends to upstream of the intersection point I of the first and the second segment 240, 250 of the light guide 24 in order to ensure the correct positioning of the connecting portions 242, 252 of the first and the second segment 240, 250 of the light guide 24 and the correct positioning of the intersection point I. in other words, the convergence of the exits 230, 232 makes the segments cross in such a way as to ensure loss-free propagation of the light in the segments.

The intersection point I of the first and the second segment 240, 250 of the light guide 24 is not covered by the first and the second exit 230, 232 of the light engine 22 so as to create a continuous line of light formed by the lighting portions 244, 254 of the first and the second segment 240, 250 of the light guide 24 of the luminous device 200, that is to say extending from the second end 240B of the first segment 240 to the second end 250B of the second segment 250 of the light guide 24.

In the second embodiment of the luminous device 200, the first and the second guide sleeve 26, 28 of the first embodiment are replaced by the convergent first and second exits 230, 232, respectively, of the light engine 22.

The luminous device 200 according to a third embodiment, which is not shown, is a combination of the first and second embodiments of the luminous device 200. Consequently, such a luminous device 200 comprises a light engine 22 wherein the first and the second exit 230, 232 are convergent, in combination with a first and a second guide sleeve 26, 28 of the first and the second segment 240, 250 of the light guide 24.

It is beneficial to repeat the point common to the three above-described embodiments. Specifically, the light engines proposed in the three embodiments all allow an intersection of the distinct, or separate, segments forming part of an element referred to as a light guide. The intersection, also referred to as crossing, of the segments is a state in which the segments, at a given point, in this case the intersection point I, are placed one on top of the other and in which for each of the segments, the light exit receiving the segment in question and the second end of this segment lie one on each side of the plane of symmetry P1. Described differently, the segment that receives light from the light source located to the right of the light engine, in this case the segment 240 and the source 220, will have its lighting portion 244 located to the left of the light engine. The terms “left” and “right” are defined for example with respect to FIG. 3 or FIG. 4.

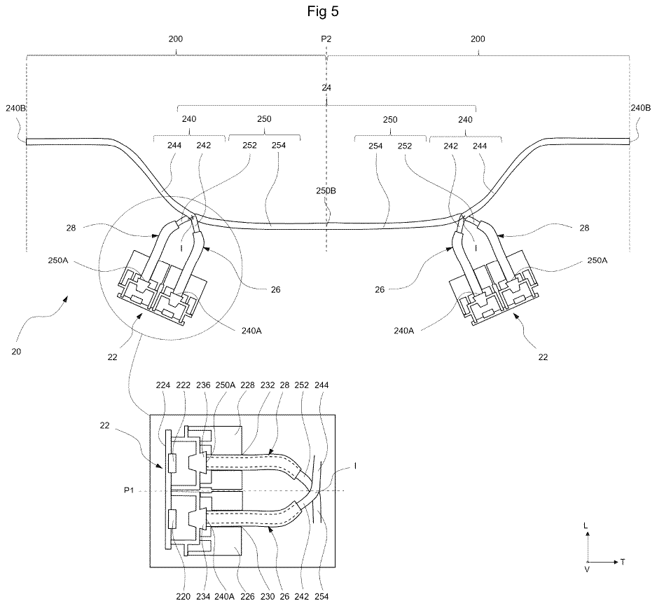

FIG. 5 shows a lighting assembly 20 configured to be arranged in a front part 10 of an automotive vehicle, in particular in the radiator grille 14 of the vehicle. The lighting assembly 20 comprises two luminous devices 200 according to the exemplary embodiment 30 illustrated in FIG. 3. Of course, the luminous devices 200 illustrated in FIG. 4 can also be used as an alternative to or in combination with the example illustrated in FIG. 3.

Each light engine 22 of the lighting assembly 20 is arranged at one end of the radiator grille 14 in a transverse direction T. The light guide 24 extends transversely in the radiator grille 14 so as to illuminate the radiator grille 14 of the vehicle.

As illustrated in FIG. 5, the two luminous devices 200 of the lighting assembly 20 are arranged such that:
the first segments 240 of the light guide 24 form lateral segments, and the second segments 250 of the light guide 24 form intermediate segments arranged between the first and the second light engine 22,
the second ends 240B of the first segments 240 of the light guide 24 form free ends each arranged close to one of the ends of the radiator grille 14 of the automotive vehicle,
the second ends 250B of the second segments 250 of the light guide 24 are interconnected and arranged substantially in the center of the radiator grille 14 of the automotive vehicle in the transverse direction T,
the lighting portions 244 of the first segments 240 of the light guide 24 extend transversely to the end of the radiator grille 14 of the automotive vehicle, and
and the lighting portions 254 of the second segments 250 of the light guide 24 are arranged facing one another in one same plane parallel to the plane LT of the frame of reference LVT.

FIG. 5 illustrates a lighting assembly 20 comprising two luminous devices 200 according to the first embodiment of the invention. According to a variant which is not shown, the lighting assembly 20 comprises multiple luminous devices according to the first and second embodiments of the invention.

Each connecting portion 242, 252 of the first and the second segment 250 of the light guide 24 does not provide illumination visible from outside the automotive vehicle, by contrast to the lighting portions 244, 254 which illuminate the radiator grille 14 of the automotive vehicle.

According to an exemplary embodiment of the lighting assembly 20 as illustrated in FIG. 5, the lighting portions 254 of the second segments 250 of the light guide 24 are aligned relative to one another and form a continuous line so as to create a continuous line of light formed by the lighting portions 244, 254 of the first and the second segment 240, 250 of the light guide 24 of the lighting assembly 20, that is to say extending from the second end 240B of the first segment 240 of one of the two luminous devices 200 to the second end 240B of the first segment 240 of the other of the two luminous devices 200.

According to another exemplary embodiment, which is not illustrated, of the lighting assembly 20, the second ends of the second segments of the light guide are transversely spaced apart from one another.

Advantageously, the lighting assembly 20 is symmetrical with respect to a plane P2 parallel to the plane VL of the frame of reference VLT and passing through the second ends 250B of the second segments 250 of the light guide 24.

According to a particular embodiment of the lighting assembly 20, as shown in FIG. 5, the second ends 250B of the second segments 250 of the two luminous devices 200 of the lighting assembly 20 coincide so as to form one and the same second segment 250 comprising one and the same lighting portion 252. Such a light guide 24 of the lighting assembly 20 comprises three distinct segments, that is to say two first segments 240 and a single second segment 250 which interconnects the first and the second light engine 22. In this configuration, the emission of light into the second segment 250 of the light guide 24 can be controlled by each of the two light engines 22.

According to another embodiment, which is not shown, of the lighting assembly 20, the second ends 250B of the second segments 250 of the two luminous devices 200 of the lighting assembly 20 form two distinct second segments 250, the lighting portion 254 of each of which is independent of the other. Such a light guide 24 of the lighting assembly 20 comprises four distinct segments, that is to say two first segments 240 and two second segments 250 each connected to only one light engine 22. In this configuration, the emission of light into each of the two second segments 250 of the light guide 24 is controlled by a single light engine 22.

Such a luminous device 200 according to the invention makes it possible to reduce the distance to be illuminated by each of the first and the second light source 220, 222 and thus limit the effects involving a drop in the value of the luminance of the light guide 24. Moreover, such an architecture of the luminous device 200 makes it possible to control the emission of light from each of the first and the second segment 240, 250 by one and the same light engine 22. Consequently, the implementation of luminous animations in the lighting portions 244, 254 of the first and the second segment 240, 250 of the light guide 24 such as selective and sequential turning on of the light sources 220, 222 associated with this first and this second segment 240, 250 and also the presence of curved or angular portions of the light guide 24 is possible while still obtaining a constant value of the luminance along the light guide 24. Moreover, it is possible to vary the luminous intensity of the first and the second light source 220, 222 in order to create a difference in luminance between the first and the second segment 240, 250 of the light guide 24.

What is claimed is:

1. (canceled)

2. The luminous device as claimed in 6, wherein:
the first light source is arranged so as to emit light rays toward the first exit; and
the second light source is arranged so as to emit light rays toward the second exit.

3. The luminous device as claimed in claim 6, wherein the luminous device includes two identical structures which are arranged side by side such that they are symmetrical with respect to a plane of symmetry:
a first structure including:
the first light source;
a first collimator disposed in front of the first light source;
a first housing body in which the first exit is integrated, the first housing body being disposed such that the first exit faces an exit of the first collimator;
a second structure including:
the second light source;
a second collimator disposed in front of the second light source;
a second housing body in which the second exit is integrated, the second housing body being disposed such that the second exit faces an exit of the second collimator.

4. The luminous device as claimed in 3, wherein the first structure and the second structure are interconnected so as to form a single unit.

5. (canceled)

6. A luminous device comprising at least one light guide and one light engine, wherein:
the light engine includes at least one light source, at least one housing, a first exit, and a second exit, the first exit and the second exit being parallel or convergent and are each arranged in the at least one housing;
the light guide includes at least one first segment and one second segment, with each including a first end;
each of the first and second exit of the light engine receives at least part of the first and the second segment, of the light guide, such that the first end of the first segment is associated with a first light source and such that the first end of the second segment is associated with a second light source,
wherein the first and the second segment are separate from one another and overlap at an intersection point and that each segment includes:
a connecting portion extending from the first end to the intersection point between the first and the second segment, and
a lighting portion extending from the intersection point to a second end.

7. The luminous device as claimed in claim 3, wherein the first and the second segment of the light guide are crossed in such a way that the intersection point between the first and the second segment lies in the plane of symmetry of the light engine.

8. The luminous device as claimed in claim 6, wherein the lighting portions of the first and the second segment form a continuous line.

9. The luminous device as claimed in claim 6, further comprising a first and a second guide sleeve for the first and the second segment of the light guide, the first and the second guide sleeve receiving at least part of the connecting portion of the first and the second segment of the light guide.

10. The luminous device as claimed in claim 9, with each of the first and the second guide sleeve being fitted, at least partially into each of the first and the second exit of the light engine.

11. The luminous device as claimed in claim 9, wherein the first and the second guide sleeve have a greater stiffness than the light guide.

12. The luminous device as claimed in claim 6, wherein the light guide includes at least one optical fiber.

13. The luminous device as claimed in claim 6, wherein the light guide is adjustable.

14. The luminous device as claimed in claim 6, further comprising an electronic control unit configured to selectively and sequentially manage the first and the second light source.

15. A lighting assembly, comprising:
two luminous devices, with each of the luminous devices including at least one light guide and one light engine, wherein the light engine includes at least one light source, at least one housing, a first exit, and a second exit, the first exit and the second exit being parallel or convergent and are each arranged in the at least one housing. the light guide includes at least one first segment and one second segment, with each including a first end, each of the first and second exit of the light engine receives at least part of the first and the second segment, of the light guide, such that the first end of the first segment is associated with a first light source and such that the first end of the second segment is associated with a second light source, wherein the first and the second segment are separate from one another and overlap at an intersection point and that each segment includes a connecting portion extending from the first end to the intersection point between the first and the second segment, and a lighting portion extending from the intersection point to a second end,
and in that the lighting portions of the second segments of the light guide of each of the two luminous devices are arranged facing one another in one same plane.

16. The lighting assembly as claimed in claim 15, wherein the lighting portions of the second segments of the light guide of each of the two luminous devices coincide.
